(19) United States
(12) Patent Application Publication
(10) Pub. No.: US 2018/0098382 A1
(43) Pub. Date: Apr. 5, 2018

(54) ELECTRIC FIREPLACE

(71) Applicant: Way Interglobal Network, LLC, Elkhart, IN (US)

(72) Inventor: Wayne Kaylor, White Pigeon, MI (US)

(73) Assignee: Way Interglobal Network, LLC, Elkhart, IN (US)

(21) Appl. No.: 15/283,714

(22) Filed: Oct. 3, 2016

(51) Int. Cl. H05B 1/02; F24D 15/02

(52) U.S. Cl. CPC H05B 1/0275; F24D 15/02

(57) ABSTRACT

A simulated fireplace and heater is provided having a housing with a cylindrically concave front display area. The housing includes a flange that acts as a decorative bezel. Located above the concave display area is a concave panel that is curved similarly to the concave front display area. Located behind the concave panel is an electric heater that draws air from inside the housing and moves it across heating elements. Heated air then is exhausted through apertures in the concave panel. An illuminator is located inside the housing that projects light onto the underside of a semi-translucent log and a rotating flicker element. The flicker element reflects light to a diffusing panel that is located behind the log.

### BACKGROUND OF THE INVENTION

This present disclosure relates to fireplaces, particularly electric ones that provide heat. Fireplaces provide ambiance but need to be fueled with wood, petroleum, or another fuel source. Further, there is nearly always some amount of undesirable effect created by the disposal of ash, wood storage and transportation, and smoke residue. A need arose for a fireplace that provided ambiance without the need for fuel, messy ash cleanup, or maintenance. The early versions of these typically involved a hollow mold of plastic or other semi-transparent material that would be painted on the outside and a flickering light bulb would be placed behind to simulate coals and fire. Eventually these became more sophisticated, with internal rotating reflective portions that would simulate flames and vary the amount of the glowing embers. To provide heat, many fireplaces included an electric heating element and blower to distribute the heat. One example of this is U.S. Pat. No. 3,742,189.

Currently, the realism of flames and embers nears the quality of a real fire, and many have built in heaters. Previous designs have a flat front, such as the fireplace covered in U.S. Pat. Nos. 7,826,727 and 8,671,600. Some even have a convex front, such as the fireplace covered in U.S. Pat. No. D719,247. It is sometimes desired to have a curved front, but space constraints prevent the flame display area front to be curved into the living space. An improved heating fireplace with a flame simulator is needed.

### SUMMARY OF THE INVENTION

The present disclosure describes an electric fireplace with an inwardly curved front display area. The curved area is a section of a cylinder wall with the concave surface facing outwardly. Located behind the curved display area is a decorative log that has the appearance of partially consumed firewood. The log is semi-transparent to allow light that is produced underneath it to give the appearance of glowing embers. On the other side of the log is a diffusing panel that is translucent. Located adjacent the log and the diffusing panel is a flicker element that rotates and has a series of reflective elements. Light that is produced by an illuminating element is projected to the log and the flicker element, where the rotation of the flicker element displays a simulated flame on the diffusing panel. The fireplace further includes a flange for attaching the fireplace to a wall and recessing part of it into the wall. The flange further includes a decorative mantle area that is convex and overhangs the concave surface. The fireplace also includes an electric heater. The heater produces heated air that is expelled through a curved panel that is aligned with the curved display area. The heater is controlled using a control panel or remote control.

### BRIEF DESCRIPTION OF THE DRAWINGS

A preferred embodiment of this invention has been chosen wherein:

FIG. 1 is a top front isometric view of the fireplace;

FIG. 2 is a bottom front isometric view of the fireplace;

FIG. 3 is a top rear isometric view of the fireplace;

FIG. 4 is a front view of the fireplace;

FIG. 5 is a top view of the fireplace;

FIG. 6 is a bottom view of the fireplace;

FIG. 7 is a right side view of the fireplace;

FIG. 8 is a left side view of the fireplace;

FIG. 9 is a rear view of the fireplace;

FIG. 10 is a truncated section view 10-10 of the fireplace in FIG. 4;

FIG. 11 is a section view 11-11 of the fireplace in FIG. 4; and

FIG. 12 is a partial section view 12-12 of the fireplace in FIG. 4.

### DESCRIPTION OF THE PREFERRED EMBODIMENT

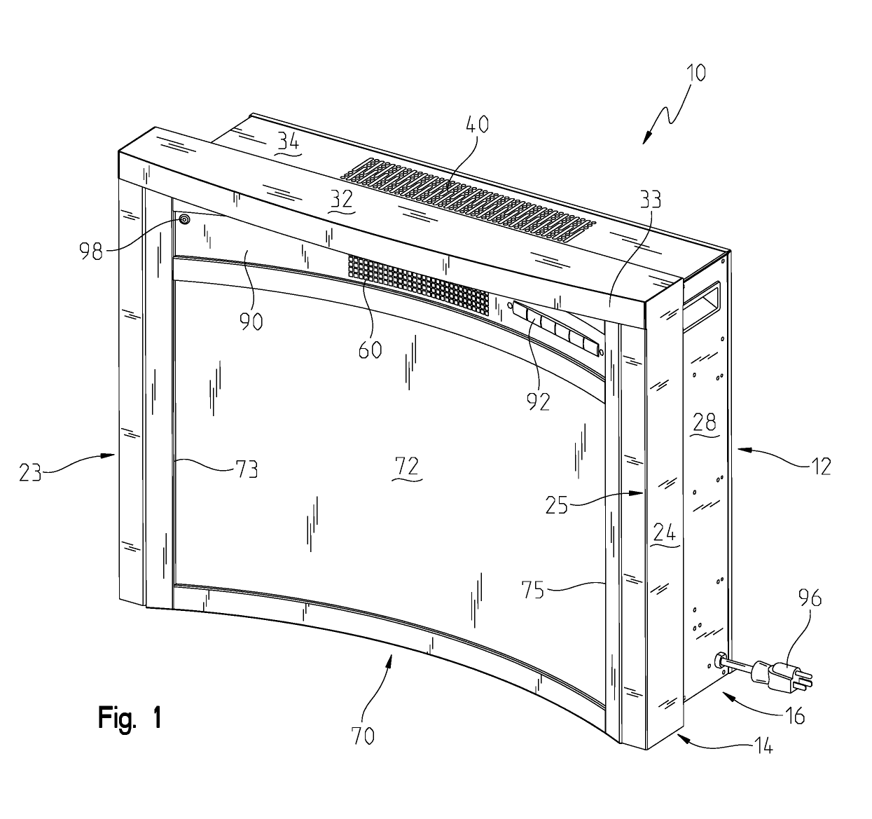

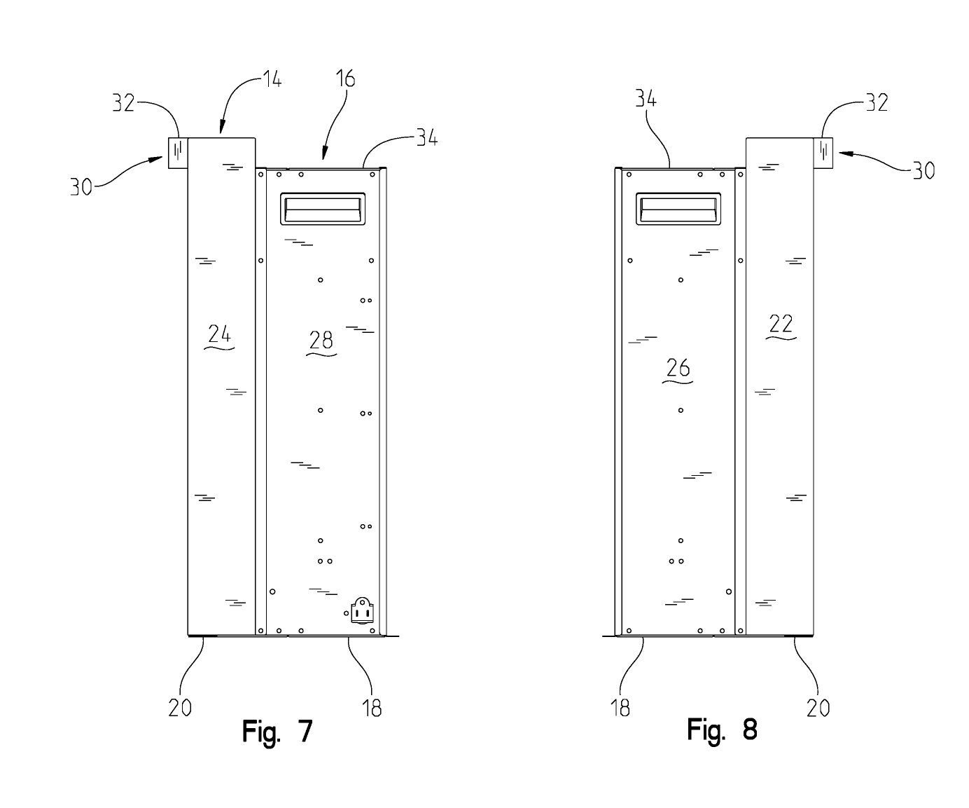

A fireplace 10, as shown in FIG.1 has a housing 12 that encloses the device and allows internal components to be mounted. The housing 12, as shown, is formed from several pieces of stamped and formed sheet metal, but it is contemplated that other forms or materials are used. The housing 12 has a top 32, 34, a bottom 18, 20, a front, a back 36, and sides 22, 24, 26, 28, that all connect to form an enclosed volume. Several sections combine to make up the front side. The housing 12 further provides mounting features to affix the fireplace 10 to another surface, such as a wall. The housing 12 has a decorative flange 14 allowing a portion 16 of the housing 12 that can be mounted flush to the wall of an existing structure. The bottom surfaces 18, 20 of the housing 12 are shown as coplanar, but it is contemplated that the surfaces are parallel or angled with respect to each other. The bottom surfaces 18, 20 are coplanar to allow the fireplace 10 to be freestanding and stable from tipping. The sides 22, 24 of the flange 14 protrude outwardly with respect to the sides 26, 28 of the housing 12, respectively. Outside edges of the sides 22, 24 have lateral edges 23, 25 respectively, shown in FIGS. 7-8. The lateral edges 23, 25 define a plane 62. The flange 14 further includes a mantle 30 portion. The top 32 of the mantle 30 is taller than the top 34 of the housing 12. The mantle 30 and sides 22, 24 protrude outwardly from the housing 12 to allow the user to mount the housing 12 partially into a recess in a wall and have the gap between the fireplace 10 and the wall be concealed. The mantle 30 has a curved front 33 that is convex as viewed from the front. The midpoint of the curved front 33 is furthest from the back 36. It is contemplated that the front 33 is flat. While the flange 14 is shown as attached, the flange 14 can be removed separately from the housing 12 for greater flexibility in attaching the fireplace 10 to a wall or allowing it to be freestanding.

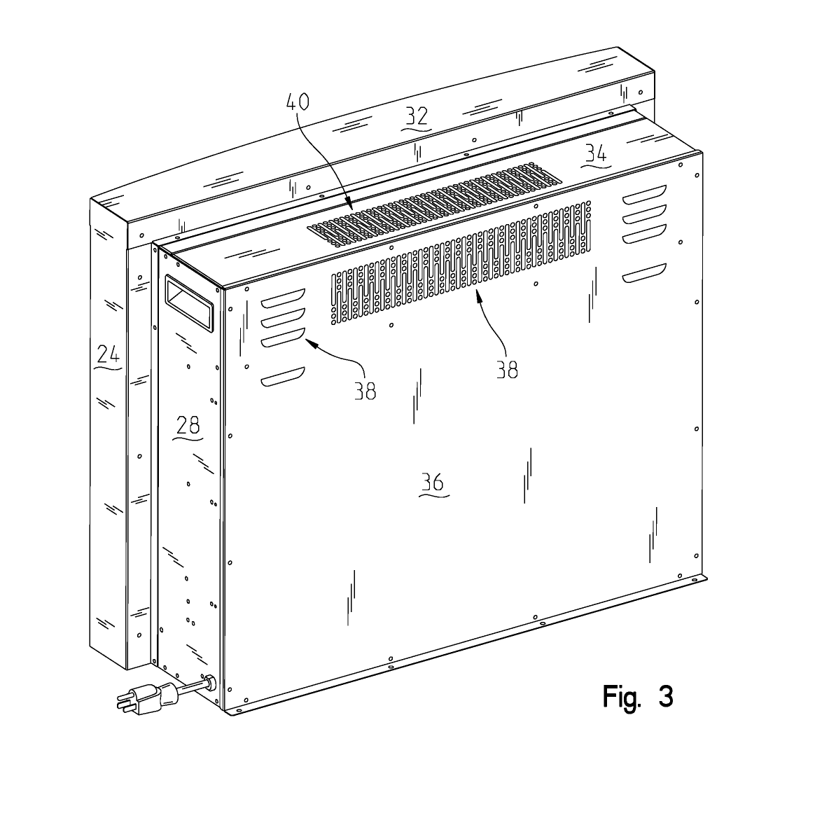

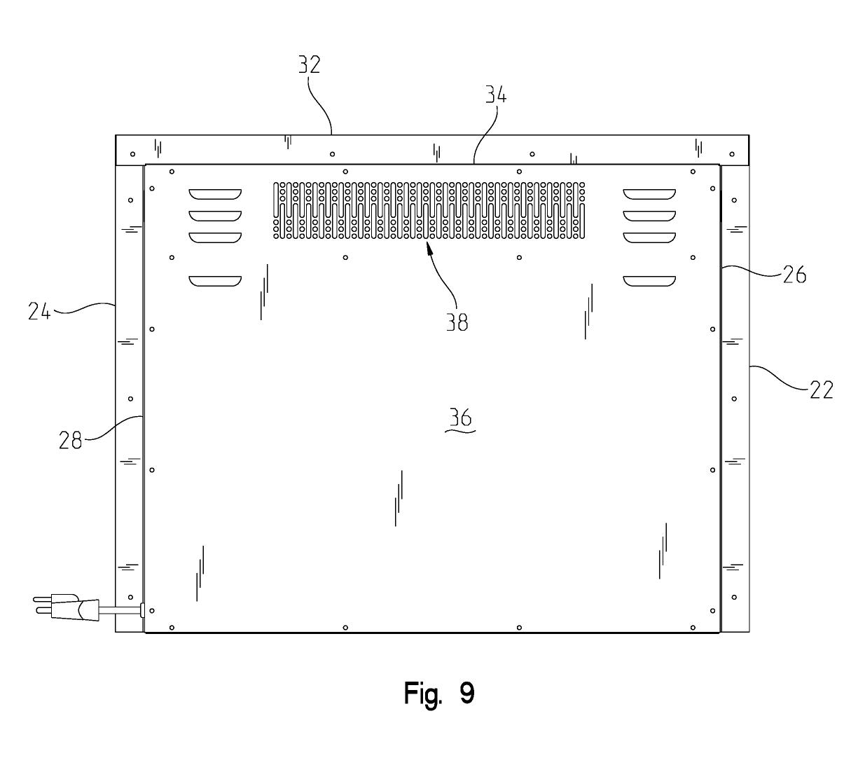

FIGS. 3 and 9 show the back 36 has an opening 38 near the top. The opening 38 allows for ventilation and air intake for the interior components of the housing 12. The housing 12 has an additional opening 40 on the top 34 and located adjacent to the opening 38.

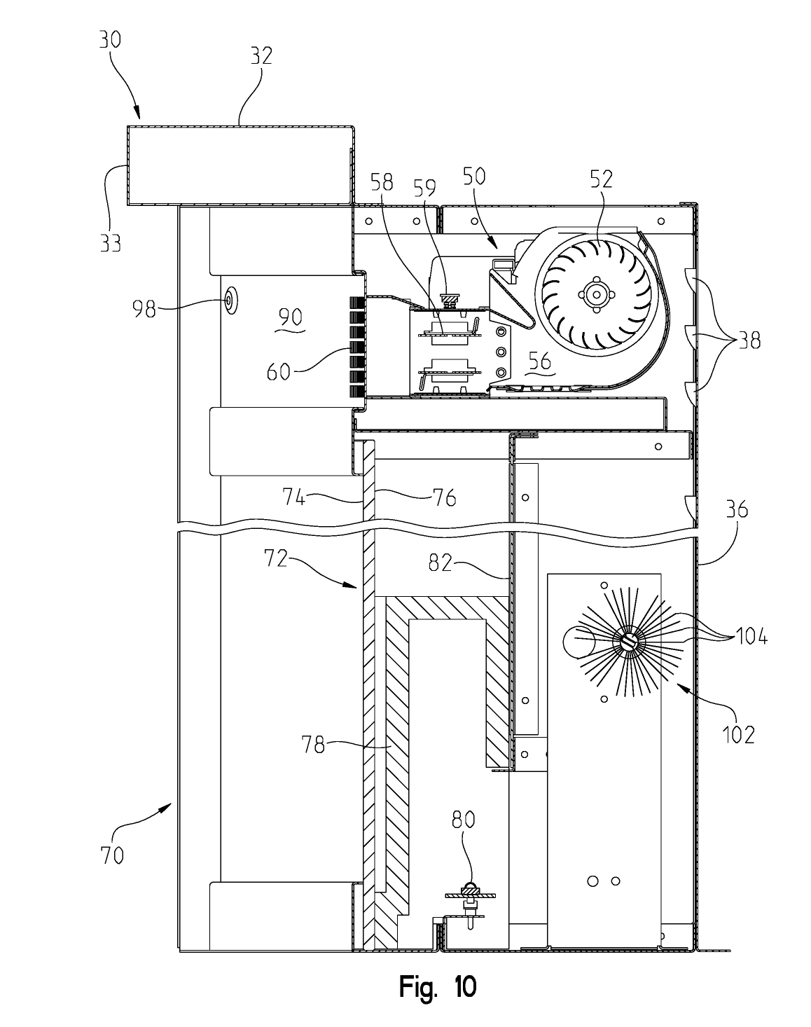

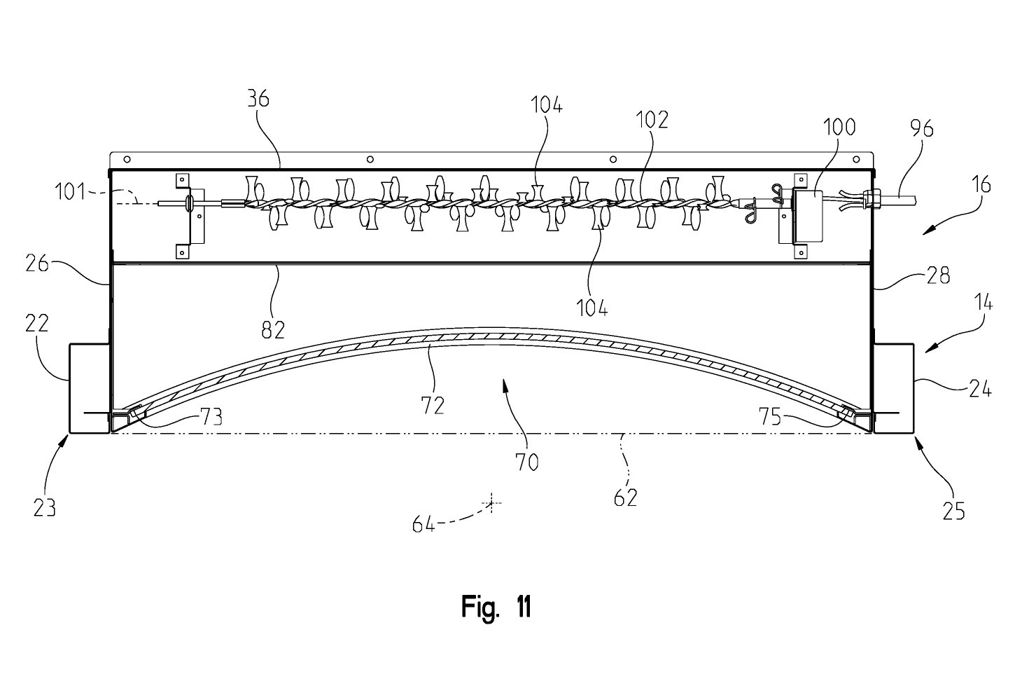

The fireplace 10 has a flame display area 70 that is decorative and provides a viewable area for the user to observe the simulated fire, shown in FIG. 10. The concave front window 72 is a transparent or semi-transparent material that is curved about an axis 64 that is shown as a constant radius to the axis 64, but it is contemplated the radius can vary with respect to the axis 64 around the curve. The curvature can also be defined as it relates to a plane 62, shown in FIG. 11. The plane 62 extends between the front surfaces of the sides 22, 24. The window 72 has lateral edges 73, 75 that are parallel to the sides 22, 24 and a midpoint located between the two. The lateral edges 73, 75 are close to the plane 62, while the midpoint is furthest from the plane 62 and closest to the back 36. As shown, the front window 72 is a partial radial section of a cylindrical wall. It is further contemplated that the front window 72 is curved about a point or an area, making it take other forms of concavity. The front window 72, as viewed from the front, is concave with an outside facing side 74 and an inside facing side 76, with both sides 74, 76 being equally separated, creating a uniform thickness. The flame display area 70 further includes a log 78, which is formed from a material that can transmit some light and will accept a coating and texture to simulate burned logs, partially burned logs and/or coals. The log 78 is shown as simplified, but would feature a texture in practice to simulate a real log. This texture would be viewable through the front window 72. A light source 80 is located underneath, allowing light to illuminate portions of the log 78. The light source 80 is shown as using LED technology, but other light sources are anticipated. The light source 80 provides unfocused light in a general upward direction, but focused or omnidirectional light sources are anticipated. Located adjacent to the log 78 is a translucent diffusing panel 82, which acts to diffuse any light projected onto it. The diffusing panel 82 is parallel to and spaced from the plane 62. The diffusing panel 82 is shown as smooth but could have a brick texture or feature other textures.

An electric motor 100 rotates an elongate flicker element 102 about a central axis 101, as seen in FIG. 11. The flicker element 102 has a series of reflective elements 104 that extend outwardly from the central axis 101 that reflect some light from the light source 80 and shine the light on the diffusing panel 82. The rotation of the flicker element 102 and irregularity of the reflective elements 104 create a simulated flame that is visible from the flame display area 70. The direction of rotation (clockwise as viewed in FIG. 10) causes the flames to appear to rise up from the log 78. Rotating flicker elements are well known in the art.

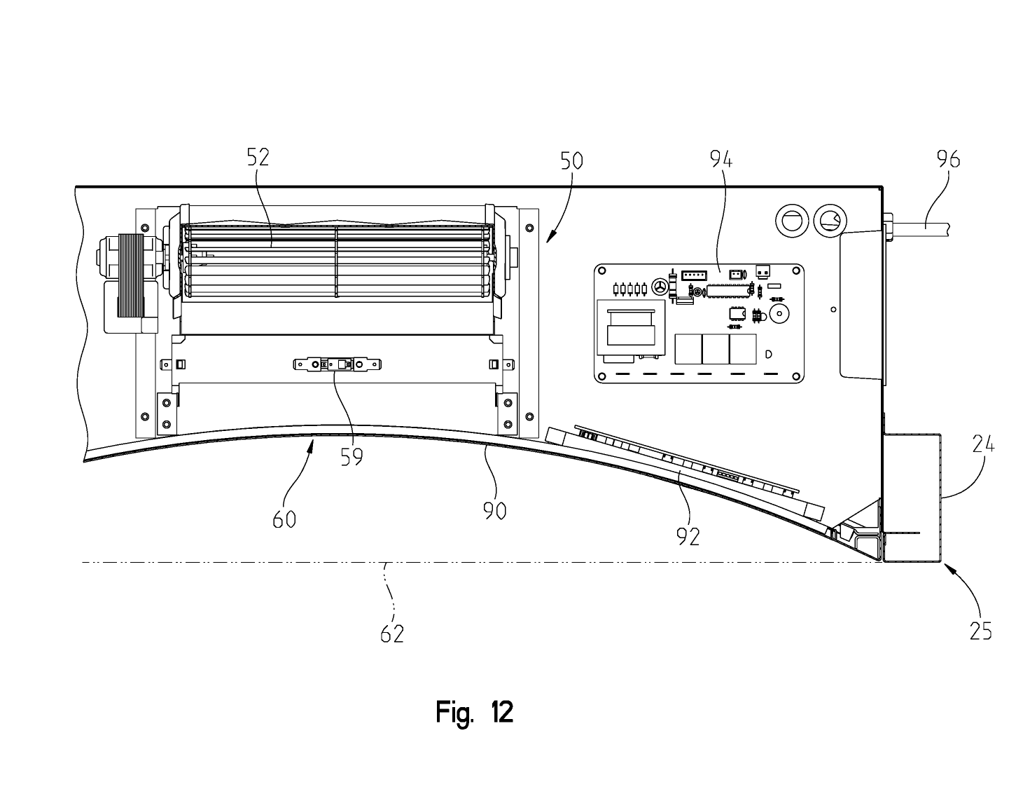

FIG. 10 shows a heater 50 is located inside the housing 12 adjacent to the openings 38, 40. The openings 38, 40 allow for air to be drawn into the housing 12 and supply the heater 50 with air. A blower 52 pulls air from an intake and moves it through a duct 56 and then blows across heating elements 58. As shown in FIG. 12, the blower 52 uses a “squirrel cage” style of fan, but other types of fans and blowers are contemplated. A thermostat controls the amount of heat that is produced by the heating elements 58. Safety devices such as over-temperature cutout 59 and short-circuit protection are commonplace and well known in the art. Heated air is released through an opening 60 in a curved panel 90. As shown, the heater 50 is a forced air style, but other heating methods are contemplated, such as radiant. The heater 50 is shown located near the top of the housing 12 but it is contemplated that it is located along the bottom or on one of the sides.

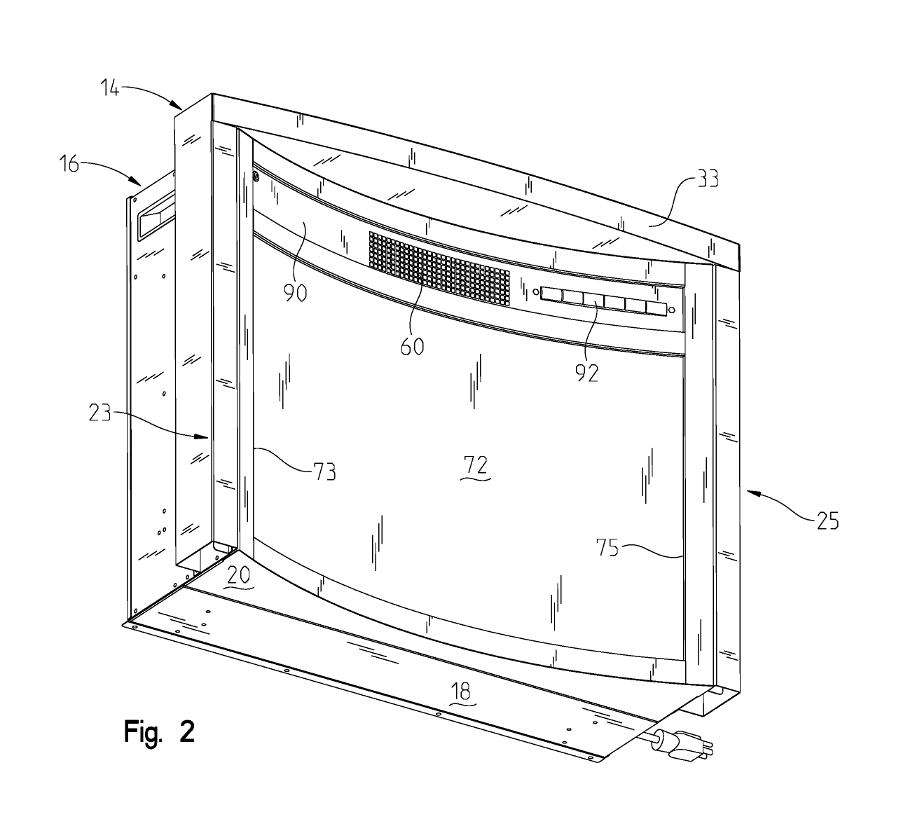

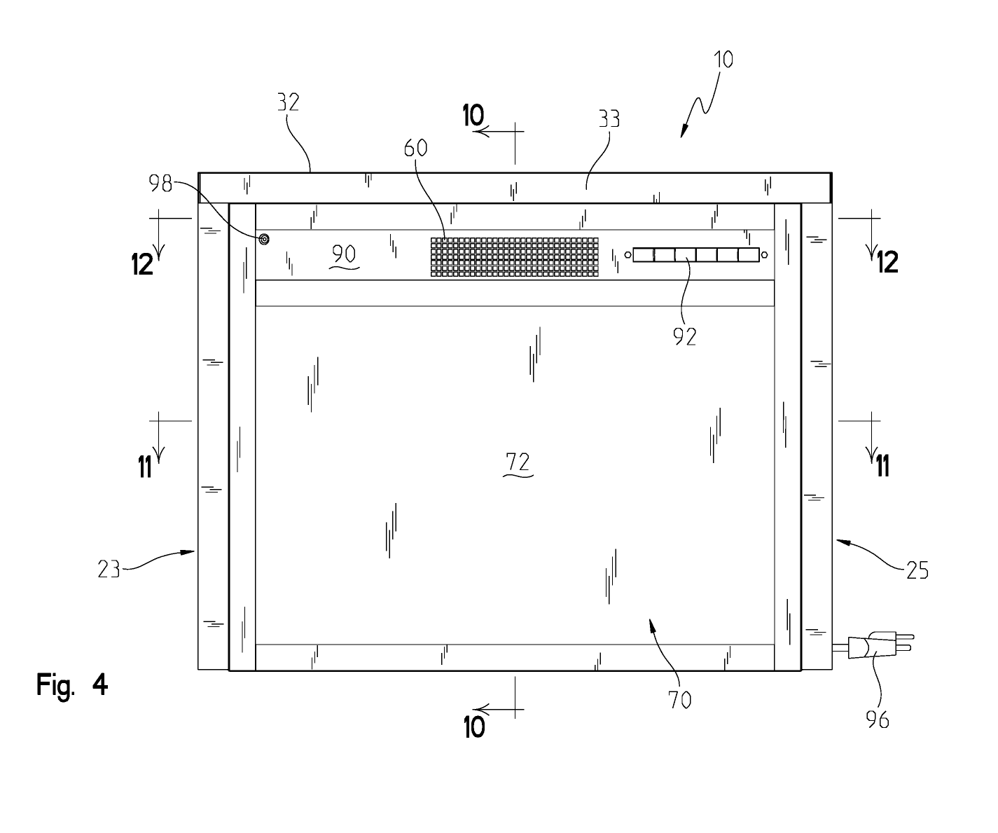

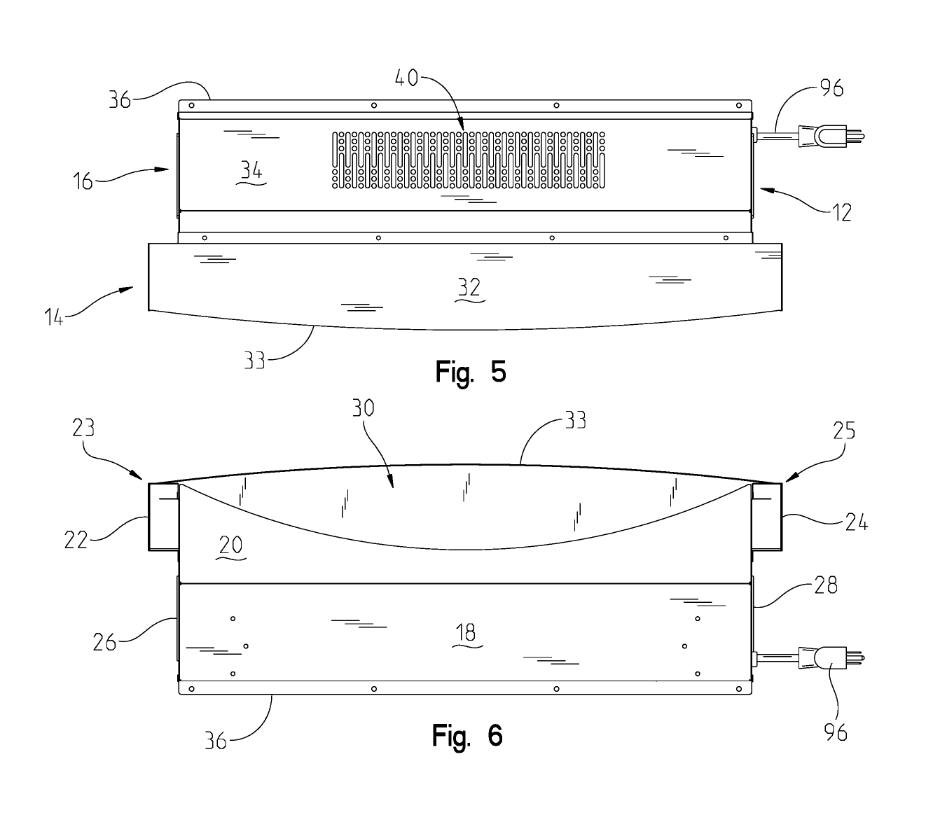

Located above the front window 72 is the curved panel 90. The curved panel 90 has a similar curvature that is close to the front window 72. The curved panel 90 and front window 72 make up the front of the fireplace 10. The curved panel 90 has a control panel 92 mounted thereto, where the user can adjust the heating and flame settings, shown in FIG. 2. It is contemplated that a timer that controls the heater and/or flame settings is also controlled by the control panel 92. The control panel 92 may be wired to a main circuit board 94, where household current from the cord 96 is used to power the heater 50, light source 80, blower 52, and other related components. It is contemplated that the circuit board 94 is located elsewhere inside the housing 12, or integral to the control panel 92. It is commonplace with electric fireplace simulators that a remote control (not shown) is used to control the various features of the fireplace 10. The remote control is typically infrared (IR), which requires a receiver 98, shown in FIG. 4. Further, a display that provides information to the user about current settings is contemplated. The display could either be part of the curved panel 90 or located adjacent to the front window 72.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A simulated fireplace heater comprising:
a housing having sides, a top, a bottom, and a back, said housing having a flange extending from said sides and said top, said flange being removably affixed thereto, front edges of said sides defining a plane substantially parallel to said back and spaced therefrom, said back and said top having apertures adapted to receive air from outside said housing;
a flame display area having a concave window with an outside facing surface and an inside facing surface, said window being cylindrically concave with respect to said plane, said concave window having lateral edges substantially parallel to said sides, said lateral edges of said window are nearest said plane and a midpoint of said window between said lateral edges is further from said plane and closer to said back, said window being substantially transparent, said flame display area having a log being adjacent to said inside facing surface and formed from a material capable of partially transmitting light, said flame display area further including a diffusing panel being substantially parallel to said plane and adjacent said log, said log located between said window and said diffusing panel;
said flange having a mantle portion located above said flame display area, said mantle portion having a front mantle surface being cylindrically convex with respect to said plane, a midpoint of said front mantle surface is farthest from said midpoint of said window;
an illuminating element adapted to generate visible light, said illuminating element affixed to said housing underneath said log;
an elongate flicker element being rotatable about a central axis by a motor, said flicker element having a plurality of segmented reflective portions adapted to reflect said visible light;
a heater having a blower and a heating element, when said blower is rotating, air from inside said housing is moved over said heating element and through a plurality of apertures through a curved panel, said curved panel located above said flame display area and having a concavity substantially matching said window; and
when said illuminating element is generating said visible light and said elongate flicker element is rotating, a simulated flame is projected onto said diffusing panel and said log.

2. The fireplace of claim 1, wherein said apertures to allow said air from outside said housing to enter said blower.

3. The fireplace of claim 1, wherein said curved panel having controls adapted to control said heater, said illuminating element, and said flicker element.

4. The fireplace of claim 3, further comprising a remote separate from said fireplace, said remote adapted to control said heater, said illuminating element, and said flicker element.

5. A simulated fireplace heater comprising:
a housing having sides, a top, a bottom, and a back, said housing having a flange extending therefrom, said flange being removably affixed thereto, front edges of said sides defining a plane substantially parallel to said back and spaced therefrom, said housing having apertures adapted to receive air from outside said housing;
a flame display area having a window being concave with respect to said plane and having lateral edges being substantially parallel to said sides, said lateral edges of said window are nearer said plane, a midpoint of said window between said lateral edges being further from said plane and closer to said back, said window being substantially transparent, said flame display area having a log being adjacent to said window and formed from a material capable of partially transmitting light, said flame display area further including a diffusing panel being substantially parallel to said plane and adjacent said log, said log located between said window and said diffusing panel;
an illuminating element adapted to generate visible light, said illuminating element affixed to said housing underneath said log;
an elongate flicker element being rotatable about a central axis by a driving mechanism, said flicker element having a plurality of segmented reflective portions adapted to reflect said visible light; and
when said illuminating element is generating said visible light and said elongate flicker element is rotating, a simulated flame is projected onto said diffusing panel and said log.

6. The fireplace of claim 5, wherein said flange having a mantle portion located above said flame display area, said mantle portion having a front mantle surface being convex with respect to said plane.

7. The fireplace of claim 5, further comprising a heater having a blower and a heating element, when said blower is rotating, air from inside said housing is moved over said heating element and through a plurality of apertures through a curved panel, said curved panel located above said flame display area and having a concavity substantially matching said window.

8. The fireplace of claim 7, wherein said apertures to allow said air from outside said housing to enter said blower.

9. The fireplace of claim 8, wherein said curved panel having controls adapted to control said heater, said illuminating element, and said flicker element.

10. The fireplace of claim 9, further comprising a remote separate from said fireplace, said remote adapted to control said heater, said illuminating element, and said flicker element.

11. The fireplace of claim 5, wherein said apertures adapted to receive said air from outside said housing.

12. A simulated fireplace comprising:
a housing having a top affixed to sides, said sides affixed to a bottom, said top, said sides, and said bottom affixed a rear cover to form a partially enclosed volume, a plane extending between front edges of said sides, said plane parallel to and spaced from said rear cover;
a flame display area having a window being concave with respect to said plane and having lateral edges being substantially parallel to said sides, said lateral edges of said window are nearer said plane and a midpoint of said window between said lateral edges being further from said plane and closer to said back, said window being substantially transparent, said flame display area having a log being adjacent to said window and formed from a material capable of partially transmitting light, said flame display area further including a diffusing panel being substantially parallel to said plane and adjacent said log, said log located between said window and said diffusing panel;
an illuminating element adapted to generate visible light, said illuminating element affixed to said housing underneath said log;
a flicker element being rotatable about a central axis by a motor, said flicker element having a plurality of segmented reflective portions adapted to reflect light;
a heater having a heating element and a blower, said housing having an opening adapted to provide unheated air to said blower, said blower adapted to move said unheated air across said heating element to heat said air, said heated air exiting through an opening in a curved panel;
said curved panel located between said top and a top edge of said window, said curved panel being substantially aligned with and extending from said top edge of said window, said curved panel having a curvature being substantially equal to said window, said curved panel having a control panel adapted to control said heater, said flicker element, and said illuminating element; and
when said illuminating element is generating said visible light and said flicker element is rotating, a simulated flame is projected onto said diffusing panel and said log.

13. The fireplace of claim 12, wherein said housing including a removable bezel having sides and a mantle, said sides of said bezel affixed to said sides of said housing and extending outwardly therefrom, said mantle affixed to said top and extending outwardly therefrom.

14. The fireplace of claim 13, wherein said mantle located above said flame display area, said mantle portion having a front mantle surface being convex with respect to said plane.

15. The fireplace of claim 14, wherein said mantle having a front facing wall being curved outwardly with respect to said housing.

16. The fireplace of claim 12, further comprising a remote adapted to control said heater, said flicker element, and said illuminating element.

17. The fireplace of claim 12, wherein said curved panel having controls adapted to control said heater, said illuminating element, and said flicker element.

18. The fireplace of claim 12, wherein said top and said back of said housing having apertures adapted to receive air from outside said housing.
